(19) United States
(12) Patent Application Publication
(10) Pub. No.: US 2025/0097135 A1
(43) Pub. Date: Mar. 20, 2025

(54) Method for Monitoring a Communication Connection

(71) Applicant: Siemens Aktiengesellschaft, Muenchen (DE)

(72) Inventors: Ronny HOG, Kuemmersbruck (DE); Julia SCHWEIGER, Hirschau (DE); Sebastian SCHÖTZ, Hahnbach (DE); Markus WALTER, Bamberg (DE)

(21) Appl. No.: 18/883,460

(22) Filed: Sep. 12, 2024

(30) Foreign Application Priority Data
Sep. 15, 2023 (EP) 23197616

(51) Int. Cl. H04L 43/0852; H04L 12/40

(52) U.S. Cl. CPC H04L 43/0852; H04L 12/40; H04L 2012/4026

(57) ABSTRACT

A method for monitoring a communication connection between first and second subscribers, wherein a first processing program with a first cycle time is executed cyclically in the first subscriber, where in order to monitor the communication connection a first diagnostic unit with a first time counter is operated in the first subscriber, such that an arrival of a first telegram from the second subscriber starts the first time counter, an arrival of a second telegram from the second subscriber is monitored within a predefinable first monitoring time with the help of the first time counter, wherein a residual period is formed in the first diagnostic unit from the difference between the first monitoring time and the first time counter, and where a check is made to see whether the residual period is less than or equal to the first cycle time, and if so a monitoring signal is generated.

### BACKGROUND OF THE INVENTION

### 1. Field of the Invention

The invention relates to a method for monitoring a communication connection between a first subscriber and a second subscriber, where a first processing program with a first cycle time is executed cyclically in the first subscriber, in order to monitor the communication connection a first diagnostic unit having a first time counter is operated in the first subscriber such that an arrival of a first telegram from the second subscriber starts the first time counter, and where an arrival of a second telegram from the second subscriber is monitored within a predefinable first monitoring time via the first time counter.

### 2. Description of the Related Art

EP 1 484 655 A1 discloses a monitoring method, where the receipt of a corresponding acknowledgment signal in a further telegram is monitored during a monitoring time in response to a dispatched telegram.

For the communication between the F-CPU shown there and an output element, the “maximum response time in the event of error” is the “maximum response time without error” (in the drawing WCDTWhole)+monitoring time (PROFIsafe timeout time)+cycle of the output element−cycle of the transmitting unit.

### SUMMARY OF THE INVENTION

It is an object of the present invention to reduce a maximum response time in the event of error.

This and other objects and advantages are achieved in accordance with the invention by a method in which a residual period is formed in first diagnostic unit from the difference between the first monitoring time and the first time counter, and a check is performed to determine whether the residual period is less than or equal to the first cycle time, and if this is the case a monitoring signal is generated.

Hitherto an arrival of a new telegram, or a new correct safety PDU at an F device driver, within the monitoring time, i.e., the watchdog time, has been monitored such that if the watchdog time elapses an error response is started. The receipt of a new telegram starts the watchdog time anew. The check as to whether the watchdog time has elapsed is executed prior to the check for a new telegram.

In accordance with the invention, it is now the case that a response is already given if the residual period of the time counter for a monitoring time, in particular for a device-specific monitoring time, is less than the cycle time or is less than the device-specific cycle time.

The method is advantageously operated in a safety-related system in the case of a communication connection between the first subscriber and the second subscriber, and in this case, in the presence of the monitoring signal, the first processing program in the first subscriber is switched from received process values to substitute values, where the switch is already executed in the cycle in which the check showed that the residual period is less than or equal to the first cycle time.

In the case of a safety system, the response time not only has to be considered for a worst case, but also for a worst case in the event of error. To this end, a Safety Function Response Time (SFRT) is defined, comprising the bus runtime, cycle time of the controller, cycle time of the peripherals and of the watchdog time.

In the subscriber or component in which the monitoring time or the WD time is running, the response is not triggered when the WD time has elapsed, but rather when the residual period of the WD time is less than the cycle time of the component. This is because even if a new telegram had been received by the next cycle it is necessary to respond safely to the elapsed WD time. Owing to this solution, a cycle time of the evaluating component in which the WD time continues to run can be saved. A cycle time is advantageously now saved and thus the response time in the event of error is reduced. As a result, dimensioning of a system can be reduced, e.g., smaller safety distances can be introduced because, for example, a machine can be stopped more quickly.

The method likewise provides a time advantage when used in a communication operation from the second subscriber as an input device to a third subscriber as an output device via the first subscriber as an automation controller, as a result of which a maximum response time for an error in communication is minimized and a safe response is given to the error.

The method can also be used in a standard for a communication protocol for transferring safety-related data in automation applications with functional safety.

Until now. a Worst Case Delay Time (WCDT) was calculated and the maximum WD time plus the cycle time of the associated component in which the WD time is running was summed, as required in PROFIsafe standard IEC 61784-3-3. With the invention the method can be implemented in the PROFIsafe F-IO drivers such that the evaluation is performed automatically and thus the response time is quicker.

The method is also used, during the operation of a dangerous machine, to reduce a distance of an operator from a triggering device.

Owing to this solution, a cycle time of the evaluating component (in which the WD time is running) can be saved.

### SPECIMEN CALCULATION

CPU cycle=100 ms
Runtime of safety program (FPROG)=5 ms
BUS TIME=5 ms
F-DI (DAT=10 ms, WCDT=13 ms)
F-DO (DAT=10 ms, WCDT 16 ms)
DAT=Device Acknowledgment Time
HAT=Host Acknowledgment Time
SFRT Safety Function Response Time
Bus runtime,
Cycle time of the controller,
Cycle time of the peripherals
Watchdog time (WD time)
F-WD Time: Failsafe Watchdog Time
(->Time in which a new telegram must be received)
WCDT: Worst Case Delay Time
(maximum response time without error)
SFRT: Safety Function Response Time
(maximum response time in the event of error)
MNR MonitoringNumbers (MNR)
Monitoring Number means to ensure authenticity and the correct order of transmitted safety PDUs
DAT Device Acknowledgment Time
HAT Host Acknowledgment Time
Consideration for an F-communication between an F-DI and an F-CPU or SFRT for safety function where F-DI→F-CPU→F-DO

### Formula for Minimum PROFIsafe Monitoring Time (WD TIME)

Formula for WD_TIME:=DAT+2xBUS+HAT(CPU-cycle)+Reserve

### Formula for Max Response Time in the Presence of an Error (SFRT)

Previous formula

SFRT_{OLD}:=WCDT+Max(WD_TIME_{FDI←→CPU}+Cycle_{CPU}−Cycle_{FDI};

WD_TIME_{CPU←→F-DO}+Cycle_{FDO}−Cycle_{CPU})

Formula with check as to current status of the as yet unelapsed WD_TIME<HAT_{CPU-cycle}

SFRT_{NEW}:=WCDT+Max (WD_TIME_{FDI←→CPU}−Cycle_{FDI}; WD_TIME_{CPU←→FDO}−Cycle_{FDO})

Comparison of SFRT_{OLD} with SFRT_{NEW} shows that the response time for SFRT_{NEW} is less by HAT_{CPU-cycle} or cycle_{FDO}.

### Specimen Calculation A

CPU cycle=100 ms, F program runtime (FPROG)=5 ms, ET200MP F-DI 16 (cycle=5 ms, DAT=10 ms, WCDT=13 ms), ET200MP F-DQ 8 (cycle=5 ms, DAT=10, WCDT 16 ms) and BUS=5

WD_TIME_{:=}100 CPU-cycle+2x5_{BUS}+10_{DAT(FDI or FDO)}+10_{Reserve}130 ms

WCDT_{:}=13_{WCDT-FDI}5_{BUS+}100_{CPU-cycle}+5_{FPROG}5_{BUS}16_{WCDT-FDO}=144 ms

SFRT_{OLD}:=144_{WCDT}+Max(130_{WD_TIME}+100_{CPU-cycle}−5_{cycle-FDI}; 130_{WD_TIME}+5_{FDO_cycle}−100_{CPU-cycle)}=144 ms+Max(225 ms; 25 ms)=369 ms

SFRT_{NEW}:=144_{WCDT}+Max(130_{WD_TIME}−5_{cycle-FDI;} 130_{WD_TIME}−100_{CPU-cycle)}=144 ms+Max(125 ms; 30 ms)=269 ms→Saving 100 ms or 27%

Since in the current cycle WD_Time stands at 30 ms (130-100) and the F cycle is 100 ms, it is possible to respond immediately.

### Specimen Calculation B

CPU cycle=30 ms, F program runtime (FPROG)=5 ms, ET200MP F-DI 16 (cycle=5 ms, DAT=10 ms, WCDT=13 ms), ET200MP F-DQ 8 (cycle=5 ms, DAT=10, WCDT 16 ms) and BUS=5 ms

WD_TIME:=30_{CPU-cycle}2x5_{Bus}+10_{DAT(FDI or FDO)}+5_{Reserve}=55 ms

WCDT:=13_{WCDT-FDI}+5_{BUS}+30_{CPU-cycle}°2_{FPROG}+5_{BUS}+16_{WCDT-FDO}=71 ms

SFRTOLD:=71_{WCDT}+Max(55_{WD_TIME}+30C_{PU-cycle}−5_{cycle-FDI};

55_{WD_TIME}+5_{cycle-FD}−30_{CPU-cycle})=71 ms+Max(80 ms; 30 ms)=151 ms

SFRTNEW:=71_{WCDT+Max}(55_{WD_TIME}−5_{cycle-FDI;} 55_{WD_TIME}−30_{CPU-cycle})

=71 ms+Max(50 ms; 25 ms)=121 ms→Saving 30 ms or 20%

Since in the current cycle WD_Time stands at 25 ms (55-30) and the F cycle is 30 ms, it is possible to respond immediately.

### Specimen Calculation C

CPU cycle=10 ms, F program runtime (FPROG)=5 ms, ET200MP F-DI 16 (cycle=5 ms, DAT=10 ms, WCDT=13 ms), ET200MP F-DQ 8 (cycle=5 ms, DAT=10, WCDT 16 ms) and BUS=5 ms

WD_TIME:=10_{CPU-cycle}2x5_{Bus}+10_{DAT(FDI or FDO)}+5_{Reserve}=35 ms

WCDT:=13_{WCDT-DI}+5_{BUS}+10_{CPU-cycle}+2_{FPROG}+5_{BUS}+16_{WCDT-FDO}=51 ms

SFRT_{OLD}:=:51_{WCDT}+Max(35_{WD_TIME}+10_{CPU-cycle}−5_{cycle-FDI};

35_{WD_TIME}+5_{cycle-FD}−10_{CPU-cycle})=51ms+Max(40 ms; 30 ms)=91 ms

SFRT_{NEW}:=51_{WCDT}+Max(35_{WD_TIME}−5_{cycle-FDI}; 35_{WD_TIME}−10_{CPU-cycle}) 51 ms+Max(30 ms; 25 ms)=81 ms→Saving 10 ms or 11%

Since in the current cycle WD_Time stands at 5 ms (35−3×10) and the F cycle is 10 ms, it is possible to respond immediately.

### Specimen calculation D:

CPU cycle=10 ms, F program runtime (FPROG)=5 ms, ET200MP F-DI 16 (cycle=5 ms, DAT=10 ms, WCDT=13 ms), ET200SP F-DQ 4 (cycle16 ms, DAT=20, WCDT 32 ms) and BUS=5 ms

WD_TIME_{FDI←→CPU}:=10_{CPU-cycle}+2x5_{BUS}+10_{DAT(FDI)}+5_{Reserve}=35 ms

WD_TIME_{CPU←→FDO}:=10_{cpu-cycle}+2x5_{BUS}+20_{DAT(FDO)}+5_{Reserve}=45 ms

WCDT:=13_{WCDT-DI}+5_{BUS}+10_{CPU-cycle}+2_{FPROG}+5_{BUS}+32_{WCDT-FDO}=67 ms

SFRT_{OLD}:=67_{WCDT}+Max(35_{WD_TIME(FDI/CPU)}+10_{CPU-cycle}−5_{cycle-FDI};

45_{WD_TIME(CPU/FDO)}+16_{cycle-FD}−10_{CPU-cycle})=67 ms+Max(40 ms; 51 ms)=118 ms

SFRT_{NEW}:=67_{WCDT}+Max(35_{WD_TIME(FDICPU)}−5_{cycle-FDI}; 45_{WD_TIME(CPU/FDO)}−10_{CPU-cycle}) =67 ms+Max(30 ms; 35 ms)=102 ms>Saving 16 ms or 13.6%

Since in the current cycle WD_Time stands at 13 ms (45-2×16) and the F-DO cycle is 16 ms, it is possible to respond immediately.

### Note:

WCDT: Worst Case Delay Time or max. response time in the absence of error.

Consideration for an F communication between an F-CPU and an F-CPU or SFRT for safety function where F-DI→F-CPU1→F-CPU2→F-DO

Formula for minimum monitoring time (WD TIME) for CPU-CPU communication

Formula for WD_TIME_{CPU-CPU}:=CPU1-cycle+2xBUS+CPU2-cycle+Reserve

Formula for max. response time in the presence of an error (SFRT, on transfer from CPU to CPU)

Previous formula

SFRT_{OLD}:=WCDT+WD_TIME_{CPU-CPU}+CPU2-cycle_{(receiver)}−CPU1-cycle₍ₜᵣₐₙₛₘᵢₜₜₑᵣ₎

Formula with check as to whether current state of the as yet unelapsed WD_TIME<CPU2-cycle_{(receiver)}

SFRT_{NEW}:=WCDT+WD_TIME_{CPU-CPU}−CPU1-cycle

Comparison of SFRT_{OLD} With SFRT_{NEW} shows that the response time for SFRT_{NEW} is less by CPU2-cycle.

### Specimen calculation E:

CPU1-cycle=50 ms, F program runtime1 (FPROG1)=5 ms, CPU2-cycle=100 ms, F program runtime2 (FPROG2)=5 ms, ET200MP F-DI 16 (cycle=5 ms, DAT=10 ms, WCDT=13 ms), ET200 MP F-DQ 8 (cycle=5 ms, DAT=10, WCDT 16 ms), BUS1_{FDI-CPU1}=5 ms, BUS2_{CPU1-CPU2}=5 ms and BUS3_{CPU2-FDO}=5 ms

WD_TIME2_{CPU1-CPU2}:=50_{CPU1-cycle}+2x5_{BUS2}+100_{CPU2-cycle}+10_{Reserve}=170 ms

WCDT:=13_{WCDT-DI}+5_{BUS1}+50_{CPU1-cycle}+5_{FPROG1}+5_{BUS}+100_{CPU2-cycle}+5_{FPROG2}+16_{WCDT-DO}=199 ms

SFRT_{OLD(Timeout-CPU-CPU)}:=199_{WCDT}+170_{WD_TIME-CPU-CPU}+100_{CPU2-cycle}−50_{CPU1-cycle}=419 ms

SFRT_{NEW(Timeout-CPU-CPU)}:=199_{WCDT}+170_{WD_TIME-CPU-CPU}−50_{CPU1-cycle}=319 ms>Saving 100 ms or 21% since SFRT_{NEW(Timeout-FDI-CPUs)} is greater
Since in the current cycle WD_Time stands at 70 ms (170-100) and the F cycle is 100 ms, it is possible to respond immediately.

SFRT_{OLD(Timeout-FDI-CPU1)}:=199_{WCDT}+80_{WD_TIME(FDI/CPU1)}30 50_{CPU1-cycle}−5_{cycle FDI}=324 ms

SFRT_{NEW(Timeout-FDI-CPU1)}:=199_{WCDT}+80_{WD_TIME(FDUCPU1)}−5_{cycle-FDI}=274 ms→less than SFRT_{NEW(Timeout-CPU-CPU)} therefore SFRT_{NEW(Timeout-CPU-CPU) decisive)}

SFRT_{OLD(Timeout-CPU2-FDO)}:=199_{WCDT}+130_{WD_TIME(CPU2/FDO)}+5_{cycle-FDO}−100_{CPU-cycle}=234 ms

SFRT_{NEW(Timeout-CPU2-FDO)}:=199_{WCDT}+130_{WD_TIME(CPU2/FDO)}−100_{CPU-cycle}=229 ms→less than SFRT_{NEW(Timeout-CPU-CPU)} therefore SFRT_{NEW(Timeout-CPU-CPU}) decisive)

Further explanations for the term “timeout”: when using PROFIsafe the person skilled in the art understands “timeout” to mean the watchdog. This watchdog checks whether a “new” valid Profisafe telegram has arrived within the watchdog time. The telegrams are sent cyclically via Profinet, e.g., every 4 ms. The PROFIsafe telegram is however only updated in the CPU in the cycle of the F program.

Assuming the F program is initiated every 30 ms and the bus cycle time is 4 ms, then a Profisafe telegram is sent at 4 ms intervals, but is only updated every 30 ms. Profinet keeps sending the old telegram until there is a new one. The Profisafe watchdog is only reset when a new telegram arrives.

The minimum watchdog time here would therefore be ˜34 ms for the system to “be able” to function at all, even though in fact a new telegram arrives every 4 ms.

However, if just one message is lost, the watchdog would activate immediately. In order to achieve better availability here, the watchdog time should be calculated more generously (program runtime of the F program, its update time, bus cycle, time for lost telegrams, etc.). Thus instead of 34 ms, e.g. 100 ms, providing that the safety requirements tolerate this.

If it is not possible to increase the watchdog, since the safety system has to respond so quickly, the cycle times of the safety program and the bus cycle time must be reduced, which may possibly require faster hardware.

The parameter “F_WD_Time” is the monitoring time in the fail-safe DP standard slave/IO standard device/PA field device. A valid current safety telegram must arrive from the target device within the monitoring time. This ensures that failures and errors are recognized and corresponding responses are triggered that keep the F-System in the safe state or put it into a safe state. The monitoring time should, on the one hand, be high enough for telegram delays to be tolerated by the communication, but in the event of error (e.g. interruption of the communication connection) the error response function should respond quickly enough. The parameter “F_WD_Time” is specified in steps of 1 ms and the value range of the parameter is limited by the GSD file.

The objects and advantages are also achieved in accordance with the invention by an automation controller which, to this end, comprises a diagnostic unit for monitoring a communication connection to an input device, and a processor configured to cyclically execute a processing program with a first cycle time, where the diagnostic unit in this case is provided with a first time counter that is started on arrival of a first telegram, and is further configured to monitor an arrival of a second telegram from the input device within a predefinable first monitoring time with the help of (via) the first time counter, where the diagnostic unit is configured to form a residual period from the difference between the first monitoring time and the first time counter, and is further configured to check whether the residual period is less than or equal to the first cycle time, and if this is the case a monitoring signal is generated.

In ab embodiment, the automation controller is formed as a controller configured for functional safety, and is configured so that in the presence of the monitoring signal the processing program switches from received process values to substitute values, where the switch is already executed in the cycle in which the check showed that the residual period is less than or equal to the first cycle time.

In accordance with the embodiments of invention, the meaning of “functional safety” is as defined in standard series International Electrotechnical Commission (IEC) 61508 “Functional Safety of Electrical/Electronic/Programmable Electronic Safety-related Systems”. This describes the use of a variety of methods for the control of errors.

For example, the avoidance of systematic errors in development, e.g., specification and implementation errors; monitoring during operation to identify accidental errors; and safe control of identified errors and transition to a state previously defined as safe.

The automation controller is further provided with a bus connection for the connection of an input device and an output device, where the diagnostic unit and the first processing program are configured to minimize a maximum response time in the event of an error in communication by providing the substitute values, and to respond safely to the error.

The automation controller is advantageously provided with a communication driver for a standardized communication protocol for the transmission of safety-related data in automation applications with functional safety.

In the component in which the WD time runs, the system does not respond when the WD time has elapsed, but when the residual period of the WD time is less than the cycle time of the component. This is because even if a new telegram had been received by the next cycle, a response must be safely made to the elapsed WD time. This would in any case happen in the next cycle, even if a telegram had come back in the meantime, because the evaluation of the residual period must occur at the start of the F program before the check for a new telegram occurs.

The objects and advantages are also achieved in accordance with the invention by an output device which is configured to receive a telegram for the output of a process value, and which is further provided with a diagnostic unit that executes the method in accordance with disclosed embodiments, and which is configured such that in the presence of the monitoring signal a switch is made from the process value to a substitute value.

In robotics in particular, the output device is formed as an integral part of an actuator in automation technology, this actuator then, for example, being a drive motor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows exemplary embodiments of the invention and further explanations, in which:

FIG. 1 shows a communication between a first subscriber and a second subscriber in accordance with the prior art;

FIG. 2 shows a communication between the first subscriber and the second subscriber with an inventive diagnostic unit;

FIG. 3 shows a diagram to illustrate a reduction of a Safety Function Response Time (SFRT) in accordance with the invention;

FIG. 4 shows the effect of the reduction of the SFRT;

FIG. 5 shows an automation controller in accordance with the invention;

FIG. 6 shows a motor with an integrated output device in accordance with the invention; and

FIG. 7 is a flowchart of the method in accordance with the invention.

### DETAILED DESCRIPTION OF THE EXEMPLARY EMBODIMENTS

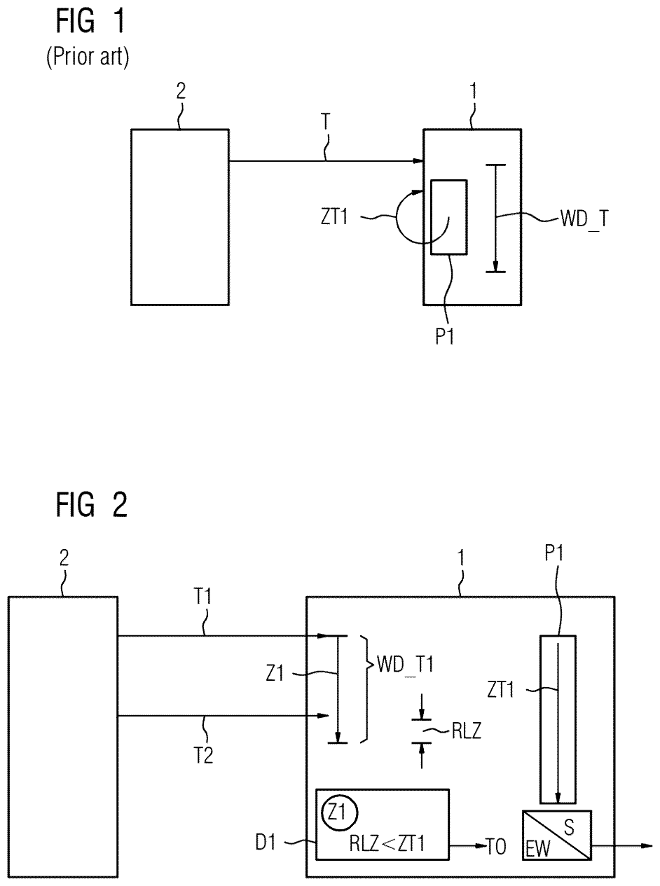

FIG. 1 shows a communication between a first subscriber 1 and a second subscriber 2. The second subscriber 2 sends a telegram T to the first subscriber 1. Upon receipt of the telegram T, a monitoring time is started for the first subscriber 1, and a watchdog time WD_T elapses. If a further telegram is not received by the first subscriber 1 by the time the watchdog time WD_T elapses, then a response is given with a function that influences the safety. This means that a response to an event influencing the safety is not given until the watchdog time WD_T has elapsed in the first subscriber 1. The first processing program P1 is executed with a first cycle time ZT1.

FIG. 2 describes the communication between the first subscriber 1 known from FIG. 1 and the second subscriber 2 using the inventive method. The first subscriber 1 is now configured so that with it a method can be performed for monitoring a communication connection between the first subscriber 1 and the second subscriber 2. In the first subscriber 1, a first processing program P1 with a first cycle time ZT1 is executed cyclically. In order to monitor the communication connection, a first diagnostic unit D1 with a first time counter Z1 is operated in the first subscriber 1, such that an arrival of a first telegram T1 from the second subscriber 2 starts the first time counter Z1. Within a predefinable first monitoring time WD_T1, an arrival of a second telegram T2 from the second subscriber 2 is monitored with the help of the first time counter Z1.

In the first diagnostic unit D1, a residual period RLZ is formed from the difference between the first monitoring time WD_T1 and the first time counter Z1. A continuous check is now made to determine whether the residual period RLZ is less than or equal to the first cycle time ZT1. In the event that the residual period RLZ is less than or equal to the first cycle time, a monitoring signal TO is generated. The first subscriber 1 then switches from process values S to substitute values EW.

The essential advantage of the execution of the method mentioned is that it is already possible to respond if the residual period RLZ of the time counter Z1 for a monitoring time, in particular for a device-specific monitoring time, is less than the cycle time or less than the device-specific cycle time of a device.

In the example here in FIG. 2, the comparison between the residual period RLZ and the first cycle time ZT1 is used for the execution of the first processing program P1.

Switching from process values to substitute values can now already be executed in the cycle in which the check showed that the residual period is less than or equal to the first cycle time. In terms of a quick response for a safety evaluation, an entire cycle time is now saved.

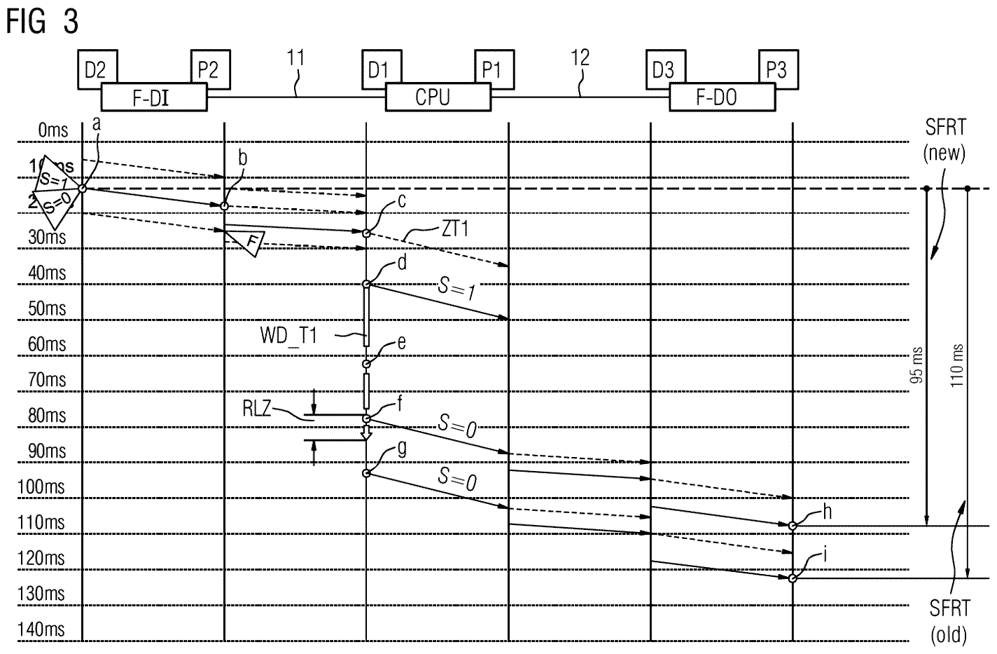

FIG. 3 shows a flow diagram for the communication from an input device F-DI to an automation controller CPU and, in turn, a communication for commands from the automation controller CPU to an output device F-DO. The input device F-DI is connected to the automation controller CPU via a first bus 11 and the output device F-DO is connected to the automation controller CPU via a second bus 12. The input device F-DI for example receives a process value S, which may be either S=1 or S=0. The process value S could, for example, be a safe function for a triggering device LG. A second diagnostic unit D2 is operated in the input device F-DI and a second processing program P2 is executed. A first diagnostic unit D1 is operated in the automation controller CPU and a first processing program P1 is executed. A third diagnostic unit D3 is operated in the output device F-DO and a third processing program P3 is executed. The aforementioned method for monitoring the communication connection is implemented in the mentioned diagnostic units D1,D2,D3. The input device F-DI sends telegrams to the automation controller CPU via the first bus 11. The telegrams contain the process value S. From a starting point a, a telegram with the process value S=1 is sent to the automation controller CPU via the first bus 11. The input device F-DI has a device-specific cycle time and so the telegram with the process value S=1 leaves the input device F-DI at a point b. The first bus 11 in turn has a bus delay time or else a telegram cycle time, so the telegram needs a certain bus runtime from point b to point c. The automation controller CPU likewise has a device-specific cycle time and so it will not be able to forward the received process value S=1 to the output device F-DO via the second bus 12 until after a cycle time at point d.

In the automation controller CPU the last identified signal S=1 starts the first monitoring time WD_T1.

However, the situation now arises in which the first bus 11 has a failure or there is an error, or the input device F-DI has failed and no new data or telegrams are transferred to the bus. This is clarified by the small triangle with the process value S=0. An error indicator F is shown below point b. Thus, there is a signal change of the process value S from S=1 to S=0, which no longer gets through to the automation controller CPU. The watchdog time or the first monitoring time WD_T1 was started at point d. The residual period RLZ of the monitoring time WD_T1 has still not elapsed at point e, but it is less than the watchdog or the first cycle time ZT1 of the automation controller CPU. Thus a response is already given now, since the monitoring time WD_T1 would definitely elapse in the next cycle. It follows from this that the signal S=1 must be set to a safe substitute value EW=0. The automation controller CPU now sends a telegram to the output device F-DO with the safe substitute value EW=0 or S=0 before the actual monitoring time has elapsed. This signal must in turn be transmitted via the second bus 12 with a certain delay time. Upon arrival at the output device F-DO, a certain delay time also elapses here until the signal or the safe substitute value EW=0 can be output. This safe output occurs at point h. Without the inventive method, in which a check is made to determine whether the residual period RLZ is less than or equal to the first cycle time ZT1, a safe substitute value would not be provided by the automation controller CPU until point g.

In accordance with the old evaluation of the monitoring time, a response is not given or issued until after the monitoring time WD_T1 has elapsed and thus in a worst case not until a cycle later. The automation controller CPU would not respond until point g to the effect that the safe substitute value EW=0 or S=0 must be sent off; this also needs its runtime via the second bus and is finally processed in the output device F-DO and can be safely output at point i with a delay. This results in an old maximum response time for an error SFRTold and a new maximum response time for an error SFRTnew. It is clear that the new maximum response time for an error SFRTnew of 95 ms is less than the old maximum response time for an error SFRTold of 110 ms.

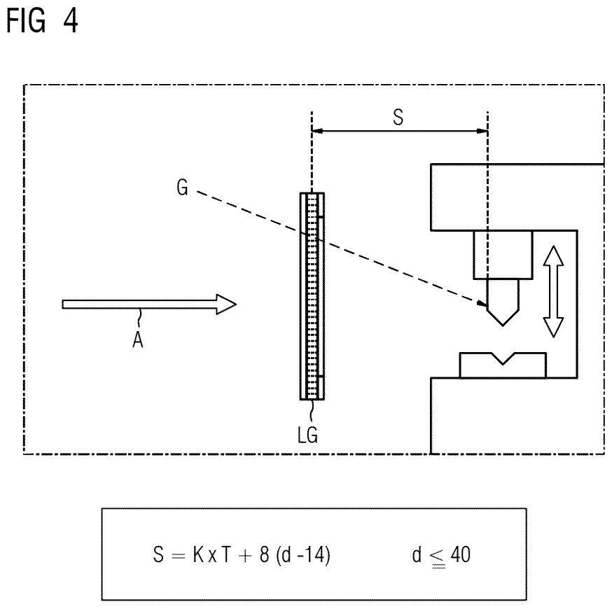

FIG. 4 clarifies the effect of a reduction in the maximum response time for an error SFRT on a specimen system. For example, a safety distance S must be kept from a press. The safety distance S is measured between a danger zone G and the installation location of a triggering device LG, which in this example is a light array. Now, for example, a human hand could reach into the press from a direction of approach A, in which case a signal would be triggered via the triggering device LG. As described in FIG. 3, this signal must be transmitted by the individual components and the buses to an output device with a delay. In the communication calculation for this described system operation according to FIG. 4, the SFRT has decreased from 369 ms to 269 ms in the example. Because of this reduction in the SFRT by 100 ms, the safety distance S of the triggering device LG from the danger zone G can be reduced by 200 mm.

The safety distance S can be calculated with the formula S=K·8+P+8·(D−14), as shown. An approach velocity K is assumed to be 2000 m/s. This would correspond to a penetration velocity of a human hand. T is calculated as the maximum required stopping time of the machine plus the reaction time of the triggering device or the detection capability D of a light curtain.

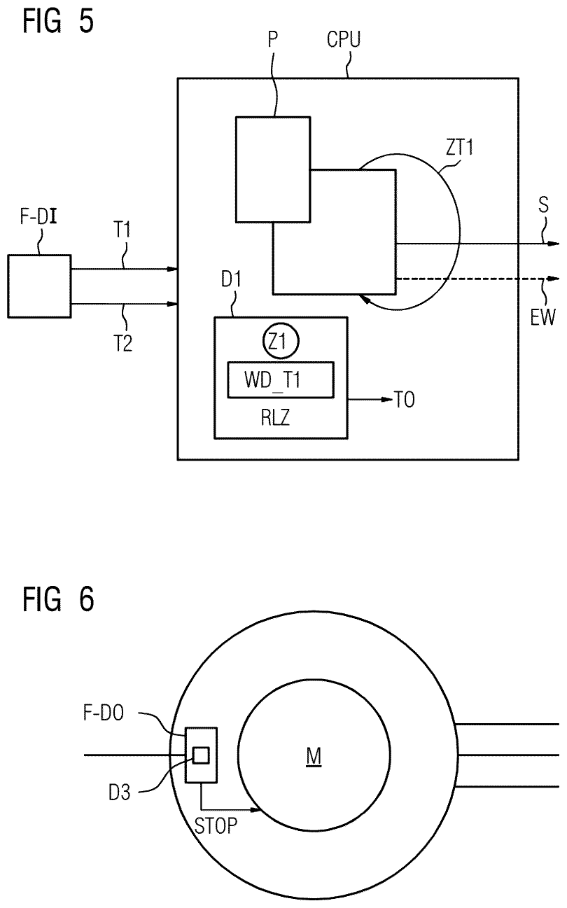

FIG. 5 once again schematically shows the automation controller CPU described in FIG. 4. The automation controller CPU comprises a diagnostic unit D1 for monitoring a communication connection with an input device FDI; the automation controller CPU further comprises a processor P that is configure to cyclically execute the processing program P1. The processing program P1 is executed in the automation controller CPU with a first cycle time ZT1. The diagnostic unit D1 is provided with a first time counter Z1 that is started upon arrival of a first telegram T1. The diagnostic unit D1 is further configured to monitor an arrival of a second telegram T2 from the input device F-DI within a predefinable first monitoring time WD_T1 with the help of (via) the first time counter Z1. In order to now reduce the maximum response time for an error SFRT, the diagnostic unit D1 is configured to form a residual period RLZ from the difference between the first monitoring time WD_T1 and the first time counter Z1 and is further configured to check whether the residual period RLZ is less than or equal to the first cycle time ZT1, and if this is the case a monitoring signal TO is generated. It is now possible to switch from process values S to safe substitute values EW ahead of time.

FIG. 6 shows an output device F-DO as an integrative part of a servomotor M for a robot. If the output device F-DO with its third diagnostic unit D3 is implemented or integrated directly in the motor of a robot, then it is possible to respond even more quickly to a stop signal.

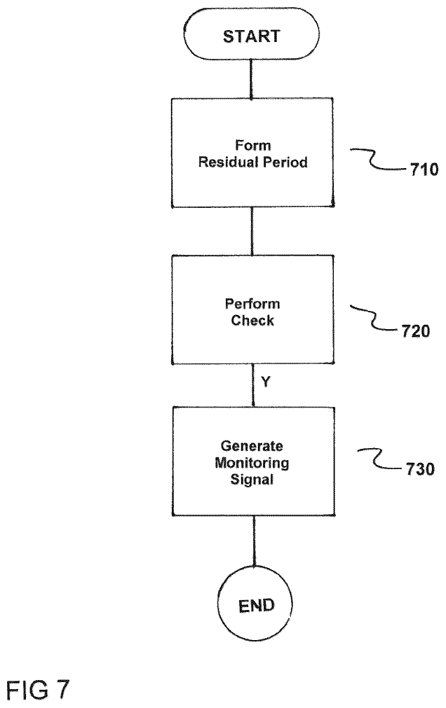

FIG. 7 is a flowchart of the method for monitoring a communication connection between a first subscriber 1 and a second subscriber 2, where a first processing program P1 with a first cycle time ZT1 is executed cyclically in the first subscriber 1, a first diagnostic unit D1 with a first time counter Z1 is operated in the first subscriber 1 to monitor the communication connection, such that an arrival of a first telegram T1 from the second subscriber 2 starts the first time counter Z1, and where an arrival of a second telegram T2 from the second subscriber 2 is monitored within a predefinable first monitoring time WD_T1 via the first time counter Z1.

The method comprises forming a residual period RLZ from a difference between the first monitoring time WD_T1 and the first time counter Z1 in the first diagnostic unit D1, as indicated in step 710.

Next, a check is performed to determine whether the residual period RLZ is less than or equal to the first cycle time ZT1, as indicated in step 720.

Next, a monitoring signal TO is generated if the residual period RLZ is less than or equal to the first cycle time ZT1, as indicated in step 730.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for monitoring a communication connection between a first subscriber and a second subscriber, a first processing program with a first cycle time being executed cyclically in the first subscriber, a first diagnostic unit with a first time counter being operated in the first subscriber to monitor the communication connection, such that an arrival of a first telegram from the second subscriber starts the first time counter, and an arrival of a second telegram from the second subscriber being monitored within a predefinable first monitoring time via the first time counter, the method comprising:
forming a residual period from a difference between the first monitoring time and the first time counter in the first diagnostic unit;
performing a check to determine whether the residual period is less than or equal to the first cycle time; and
generating a monitoring signal if the residual period is less than or equal to the first cycle time.

2. The method as claimed in claim 1, wherein the communication connection between the first subscriber and the second subscriber is operated in a safety-related system, wherein the first processing program in the first subscriber is switched from received process values to substitute values when the monitoring signal is present; and wherein the switch is executed in the cycle in which the check indicated the residual period is less than or equal to the first cycle time.

3. The method as claimed in claim 1, wherein the method is implemented in a communication operation from the second subscriber as an input device to a third subscriber as an output device via the first subscriber as an automation controller, such that a maximum response time for an error in the communication is minimized and a safe response is assigned to the error.

4. The method as claimed in claim 2, wherein the method is implemented in a communication operation from the second subscriber as an input device to a third subscriber as an output device via the first subscriber as an automation controller ( ), such that a maximum response time for an error in the communication is minimized and a safe response is assigned to the error.

5. The method as claimed in claim 1, wherein the method is implemented in a standard for a communication protocol for transmission of safety-related data in automation applications with functional safety.

6. The method as claimed in claim 1, wherein the method is implemented to reduce an operational distance of an operator from a triggering device during operation of a dangerous machine.

7. An automation controller comprising:
a diagnostic unit for monitoring a communication connection to an input device;
a processor configured to cyclically execute a processing program with a first cycle time, the diagnostic unit including a first time counter which is started on arrival of a first telegram, and being further configured to monitor an arrival of a second telegram from the input device within a predefinable first monitoring time via the first time counter,
wherein the diagnostic unit is further configured to form a residual period from a difference between the first monitoring time and the first time counter and is further configured to check whether the residual period is less than or equal to the first cycle time, and to generated a monitoring signal if the residual period is less than or equal to the first cycle time.

8. The automation controller as claimed in claim 7, wherein the automation controller is configured for functional safety; wherein the processing program is switched from received process values to substitute values when the monitoring signal is present; and wherein the switch is already executed in the cycle in which the check showed that the residual period is less than or equal to the first cycle time.

9. The automation controller as claimed in claim 7, further comprising:
a bus connection for connection of an input device and an output device;
wherein the diagnostic unit and the first processing program are configured to minimize a maximum response time for an error in the communication by providing the substitute values and to issue a safe response to the error.

10. The automation controller as claimed in claim 8, further comprising:
a bus connection for connection of an input device and an output device;
wherein the diagnostic unit and the first processing program are configured to minimize a maximum response time for an error in the communication by providing the substitute values and to issue a safe response to the error.

11. The automation controller as claimed in claim 7, further comprising:
a communication driver for a standardized communication protocol for transmission of safety-related data in automation applications with functional safety.

12. The automation controller as claimed in claim 8, further comprising:
a communication driver for a standardized communication protocol for transmission of safety-related data in automation applications with functional safety.

13. The automation controller as claimed in claim 9, further comprising:
a communication driver for a standardized communication protocol for transmission of safety-related data in automation applications with functional safety.

14. An output device configured to receive a telegram for the output of a process value, comprising:
a diagnostic unit configured to:
form a residual period from a difference between a first monitoring time and a first time counter;
perform a check to determine whether the residual period is less than or equal to the first cycle time; and
generate a monitoring signal if the residual period is less than or equal to the first cycle time;
wherein a switch from the process value to a substitute value occurs when the monitoring signal is present.

15. The output device as claimed in claim 14, wherein output device forms an integrative part of an actuator in automation technology.
